(19) United States
(12) Patent Application Publication
(10) Pub. No.: US 2026/0126283 A1
(43) Pub. Date: May 7, 2026

(54) OPTICAL PATH LENGTH SENSOR

(71) Applicant: LUMIARY AB, Härnösand (SE)

(72) Inventor: Per GRÖN, Härnösand (SE)

(21) Appl. No.: 19/118,261

(22) PCT Filed: Sep. 27, 2023
(86) PCT No.: PCT/EP2023/076696

§ 371 Date: Apr. 3, 2025

(30) Foreign Application Priority Data
Oct. 6, 2022 (EP) 22199999.8

(51) Int. Cl. G01B 9/02003; G01B 9/02015; G01B 11/02; G01H 9/00

(52) U.S. Cl. CPC G01B 9/02003; G01B 9/02027; G01B 11/02; G01H 9/004

(57) ABSTRACT

An optical path length sensor for sensing a physical quantity of an external source includes a plurality of lasers, each having an optical resonator and a gain medium to produce a laser beam in the optical resonator. At least one of the optical resonators is configured to modulate the optical frequency of the laser beam when exposed to the external source. The sensor further includes a common carrier, in which the optical resonators are arranged, and a device configured to receive light from the plurality of lasers and to determine a difference between the optical frequencies of the laser beams. In another aspect the optical path length sensor includes a plurality of interferometers, each being an asymmetric Mach-Zehnder or an asymmetric Michelson interferometer, at least two of the plurality of interferometers having a different optical path length imbalance.

### FIELD OF THE INVENTION

This invention relates to techniques for sensing by means measuring optical path length, in particular to an optical path length sensor for sensing a physical quantity of an external source. Such an external source may effect e.g. a displacement to be measured, for instance in the microscopic scale or smaller, or a change in a refractive index. An example may include a pressure sensor or a microphone.

### BACKGROUND

Interferometry is a widely used method for measuring optical path length. It is used in many applications including sensing of displacement, temperature, pressure, sound, ultrasound, concentration of gasses and chemical substances in various media, and aerosolized particles. Interferometric sensors provide improved resolution, but there are limits to how well they can perform. When optical power is limited, which is common for example in battery powered devices, the resolution of many interferometers is fundamentally limited by optical shot noise.

The resolution limit of interferometry caused by optical shot noise is not an inherent limit of nature; it is possible to achieve higher resolution using engineered quantum states of light, such as with squeezed light or entanglement. Because of the fragile nature of these exotic states, it is difficult to achieve large improvements in resolution with this approach, and these techniques have so far seen only limited use in commercial applications.

With shot noise limited measurements, the resolution increases with the square root of optical power. This is worse than the ultimate resolution limit for sensors as dictated by quantum physics, the Heisenberg limit, which is that the resolution of a sensor can increase at most at the same rate as the number of times the measured object is interrogated (for example, the number of times a photon bounces off a mirror).

### SUMMARY OF THE INVENTION

It is an object of the invention to provide for an optical path length sensor, which has improved sensitivity. This object is achieved by the sensor as defined in claim 1 or 10. The further claims specify preferred embodiments of the sensor.

According to a first aspect there is provided a sensor, which comprises a plurality of lasers, each of which comprises an optical resonator, and a common carrier, in which the optical resonators are arranged. Preferably, each of the plurality of lasers comprises a gain medium placed within the optical resonator to produce by means of a pump source a laser beam in the optical resonator. At least one of the optical resonators is configured to modulate the optical frequency of the laser beam in the optical resonator when exposed to the external source.

The provision of a plurality of lasers has the advantage that laser beams with different optical frequencies can be produced, which can be compared to improve the measuring accuracy. The provision of a common carrier has the advantage that unwanted noise effects the optical resonators in the same way. The sensor may be configured such that its resolution is significantly increased without a quadratic increase in power consumption as is required in shot noise limited schemes, and enables a design which is compact and which may be fabricated at low cost.

Preferably, the common carrier of the sensor is configured to mechanically couple the optical resonators such that unwanted noise appears as a common mode signal in the frequency of the plurality of lasers.

Preferably, the sensor is configured to sense a physical quantity varying in time within a frequency range, wherein the carrier, which holds the optical resonators in place, is free of a mechanical resonance frequency that overlaps with the frequency range. An optical resonator may comprise a deformable element whose lowest resonance frequency is higher than the upper limit of the frequency range to be sensed.

Preferably, the carrier forms a rigid body. An optical resonator may be configured such that part of it, e.g. a cantilever or membrane, is movable relative to the carrier. The carrier may be fabricated from a material that has a Young's modulus exceeding 60 GPa.

Preferably, the common carrier of the sensor comprises a structure with a first layer and a second layer, wherein each optical resonator of the plurality of lasers comprises a first mirror arranged on the first layer and a second mirror arranged on the second layer.

In one embodiment, the optical resonators are configured such that all of the laser beams are no more than 10 mm, preferably no more than 2 mm, from another laser beam.

In one embodiment, the carrier element comprises a first parallel plate and a second parallel plate held together with side walls, forming a hollow structure, wherein each of the optical resonators comprise a first mirror and a second mirror. The first mirror and the second mirror each comprise a reflective coating on a substrate, wherein the substrate of all of the first mirrors forms the first parallel plate and the substrate of all of the second mirrors forms the second parallel plate. The parallel plates may be constructed from a material with a Young's modulus exceeding 60 GPa. The average thickness of each of the parallel plates may exceed one tenth of the maximum distance between two of the laser beams.

Preferably, the sensor is configured to sense an input signal with a maximum input amplitude, wherein the laser produced in the at least one of the optical resonators configured to modulate the optical frequency of the laser beam in said at least one optical resonator when exposed to the external source is caused by said input signal to be tuned not more than the free spectral range of the laser cavity.

According to a second aspect there is provided a sensor, which comprises a plurality of interferometers for receiving light from at least one laser, wherein each of the interferometer is an asymmetric Mach-Zehnder or an asymmetric Michelson interferometer. At least two of the plurality of interferometers have a different optical path length imbalance.

Such a configuration has the advantage that interferometers with different filter characteristics may be provided. In one embodiment a first interferometer acts as a coarse filter and a second interferometer acts as fine filter. With this combination the optical frequency of a laser beam can be analyzed over a wide range with high resolution.

Preferably, the sensor comprises at least a second laser configured to emit a laser beam having an optical frequency and the plurality of interferometers comprises a first plurality of interferometers for receiving light from the at least one laser and a second plurality of interferometers for receiving light from the second laser, wherein at least two of the first plurality of interferometers have a different optical path length imbalance and at least two of the second plurality of interferometers have a different optical path length imbalance, wherein the electronic processing circuitry is configured to compute a difference between the optical frequency of the at least one laser and the second laser.

If the term “for example” is used in the following description, this term relates to exemplary embodiments and/or variants, which is not necessarily to be understood as a more preferred application of the teaching of the invention. The terms “preferably”, “preferred” are to be understood in a similar manner by referring to an example from a set of exemplary embodiments and/or variants, which is not necessarily to be understood as a preferred application of the teaching of the invention. Accordingly, the terms “for example”, “preferably” or “preferred” can relate to a plurality of exemplary embodiments and/or variants.

The following detailed description contains various exemplary embodiments for the optical path length sensor according to the invention. The description of a particular sensor to be regarded as exemplary only. In the description and claims, the terms “contain”, “comprise”, “have” are interpreted as “including, but not limited to”.

In this text, the term laser is used to refer to a device that emits light. The light output of a laser is referred to as a laser beam.

In this text, the term optical frequency estimation filter is used to refer to an optical arrangement with one input port and one or more output ports, such that it is possible to estimate the frequency of the laser beam at the input port by measuring and processing the light intensity at the output ports. Many embodiments of such filters are possible; this text includes some examples. The term optical frequency estimator is used to refer to a device comprising both one or more optical frequency estimation filters and electronic processing circuitry that processes the outputs from the optical frequency estimation filters to estimate optical frequencies of the one or more laser beams at the input ports of the optical frequency estimation filters.

In this text, sensors that operate by allowing the resonance frequency of a laser's cavity to be passively modulated by the sensed physical quantity and subsequently measuring the optical frequency of the emitted light are referred to as chromometric sensors because unlike interferometry the sensing is based on color modulation. This technique of sensing is referred to as chromometry. The term chromometric laser is used to refer specifically to the laser of a chromometric sensor, not including the frequency estimator component.

The present invention is based on chromometry and may use a set of techniques to suppress noise and digitize the signal with high resolution, large dynamic range and low power consumption.

One technique of the present disclosure to reduce noise may include differential sensing, where two or more lasers are used, and the optical frequency measurement device measures their optical frequency difference. By modulating the two lasers differently, for example modulating only one while keeping the other constant, or modulating them in opposite directions, it is possible to extract the signal while suppressing noise that is common between the lasers.

Sensors of the type described by the present disclosure benefit from using laser resonators where the photons on average make many roundtrips; this increases sensor resolution. One embodiment of the present disclosure uses semiconductor disk lasers (SDLs). The semiconductor disk can alternatively be replaced with a solid-state gain medium, for example a Nd:YVO₄ crystal. These embodiments are preferred over many other laser architectures because they can be engineered to have low resonator round-trip losses.

In one embodiment, the device for measuring optical frequency combines the laser beams of pairs of lasers to form beat notes. The lasers can be engineered so that the beat note frequency is low enough to be measured directly with photodetectors. This signal is then subsequently processed with a frequency estimation algorithm, preferably one that is close to fully efficient, in particular that is close to reaching the Cramer-Rao bound.

### BRIEF DESCRIPTION OF THE DRAWINGS

Sensors according to the invention are illustrated below with the aid of some exemplary embodiments. It is shown in

FIG. 1 a high level schematic of a chromometric sensor according to an embodiment of the invention,

FIG. 2 a schematic of an optical frequency estimator based on an asymmetric Mach-Zehnder interferometer (A-MZI) applicable in an embodiment of the invention,

FIG. 3 a schematic of an optical frequency estimator based on an A-MZI applicable in another embodiment of the invention,

FIG. 4 a schematic of an optical frequency estimator based on multiple A-MZIs applicable in a further embodiment of the invention,

FIG. 5 a diagram of the response of an optical frequency estimation filter comprised of multiple asymmetric A-MZIs,

FIG. 6 a diagram of the response of the photodetectors in FIG. 3,

FIG. 7 a diagram of the response of the photodetectors in FIG. 4,

FIG. 8 a high level schematic of a chromometric sensor according to an embodiment of the invention,

FIG. 9 a schematic of a chromometric sensor according to FIG. 8,

FIG. 10 a cross-sectional view of a differential chromometric laser pair according to a first embodiment of the invention,

FIG. 11 a cross-sectional view of a differential chromometric laser pair according to a second embodiment of the invention,

FIG. 12 a cross-sectional view of a differential chromometric laser pair according to a third embodiment of the invention,

FIG. 13 a cross-sectional view of a differential chromometric laser pair for measuring the displacement of a membrane according to a fourth embodiment of the invention, and

FIG. 14 a schematic of an optical frequency estimator based on an asymmetric Michelson interferometer applicable in an embodiment of the invention,

FIG. 15 a perspective view of top layer for forming a sensor,

FIG. 16 a perspective view of a spacer for forming a sensor,

FIG. 17 a perspective view of a PIC (photonic integrated circuit) with additional components for forming a sensor,

FIG. 18 a cross-sectional view of a sensor formed by assembling the components of FIG. 15 to 17,

FIG. 19 a variant of the sensor of FIG. 18,

FIG. 20 another variant of the sensor of FIG. 18,

FIG. 21 a yet another variant of the sensor of FIG. 18,

FIG. 22 a yet another variant of the sensor of FIG. 18,

FIG. 23 a yet another variant of the sensor of FIG. 18, and

FIG. 24 a yet another variant of the sensor of FIG. 18.

### DETAILED DESCRIPTION

FIG. 1 shows a high level schematic of a chromometric sensor, comprising one or more lasers 1. The respective optical frequencies of the light output corresponding to each laser is modulated by an external physical quantity that is to be sensed. The light output of the lasers is sent to one or more optical frequency estimators 2.

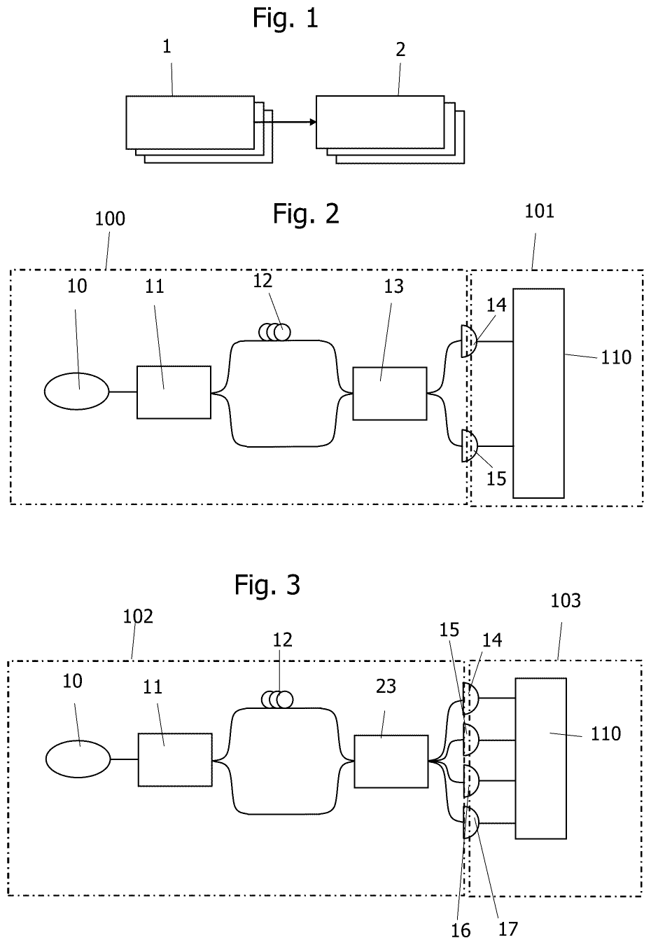

FIG. 2 shows an embodiment of an optical frequency estimator based on an A-MZI, comprising an optical part 100 and an electronic part 101. The electronic part 101 comprises electronic processing circuitry 110 that estimates the optical frequency of the input laser beam using the signals from the photodetectors. The photodetectors 14 and 15 constitute the interface between the optical part 100 and the electronic part 101 of the optical frequency estimator. The optical part 100 is in in particular configured as an optical frequency estimation filter, which comprises an asymmetric Mach-Zehnder interferometer (A-MZI). The term “asymmetric” refers to the unequal length of the arms of the interferometer (see the optical delay line 12). The optical part 100 can be constructed using for example free-space optics, fiber optics and/or photonic integrated circuit technology. One of the photodetectors 14, 15 may be omitted, whereas the electronic part 101 may be reconfigured accordingly to analyze the input signal, or they may both be connected to a differential photodetector frontend connected to the electronic processing circuitry 110.

The input laser beam 10 is directed into a 1×2 optical coupler 11, which splits the laser beam 10 into a first part, which is delayed using an optical delay line 12, and a second part, which is not delayed. The first and second parts are recombined with a 2×2 optical coupler 13. The 2×2 optical coupler 13 generates outputs which are e.g. offset by 180° and which are transmitted to a first photodetector 14 and a second photodetector 15. The optical couplers 11 and 13 may be implemented for example with fused fiber couplers or multi-mode interference (MMI) couplers in a photonic circuit. The optical delay line 12 may be implemented for example with a coiled fiber or a spiral waveguide in a photonic integrated circuit (PIC).

FIG. 3 shows another embodiment of an optical frequency estimator based on an A-MZI, as in FIG. 2, but with a 2×4 coupler 23 instead of a 2×2 coupler. The optical frequency estimator comprises an optical part 102 and an electronic part 103. The optical part 102 is an optical frequency estimation filter. One of the photodetectors in the pair of first and second photodetectors 14 and 15, or the pair of third and fourth photodetectors 16 and 17 may be omitted. Alternatively, each pair of first and second photodetectors 14, 15 or third and fourth photodetectors 16, 17 may be connected to a differential photodetector frontend.

The input laser beam 10 is directed into a 1×2 optical coupler 11, which splits the laser beam 10 into a first part, which is delayed using an optical delay line 12, and a second part which is not delayed. The first and second parts are recombined with a 2×4 optical coupler 23. The 2×4 optical coupler 23 generates outputs which are e.g. offset by 90° and which are transmitted to the first photodetector 14, the second photodetector 15, the third photodetector 16, and the fourth photodetector 17. The 2×4 optical coupler 23 is preferably configured such that the signals seen by the photodetectors constitute a quadrature signal representing the relative phase of the two input beams of the optical coupler. The 1×2 optical coupler 11 and the 2×4 optical coupler 23 may be implemented for example with fused fiber couplers or multi-mode interference (MMI) couplers in a photonic circuit. The optical delay line 12 may be implemented for example with a coiled fiber or a spiral waveguide in a PIC.

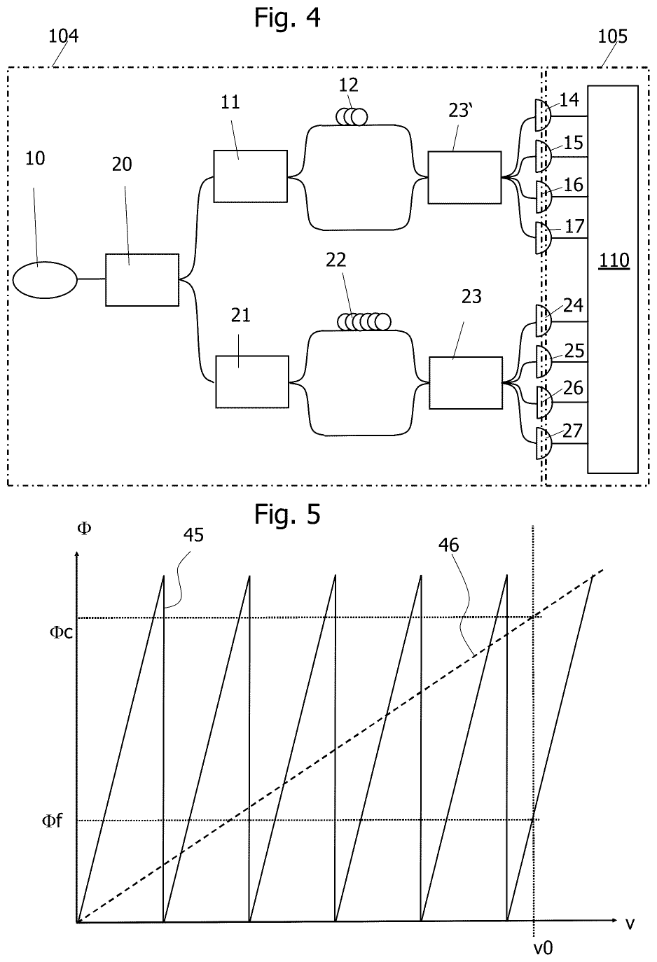

FIG. 4 shows a further embodiment of an optical frequency estimator, comprising an optical part 104 and an electronic part 105. The optical part 104 is in particular configured as an optical frequency estimation filter comprising a first A-MZI and a second A-MZI, wherein the first A-MZI of the optical part 104 is configured as a coarse filter, and the second A-MZI of the optical part 104 is configured as a fine filter. The optical delay line 22 of the fine filter is longer than the optical delay line 12 of the coarse filter. This further embodiment can be used to increase the dynamic range of the optical frequency estimation filter. Other equivalent configurations are possible: For example, instead of using three separate 1×2 optical couplers 11, 20, 21 it is possible to use a single 1×4 optical coupler. The optical coupler 23′ of the first A-MZI and the optical coupler 23 of the second A-MZI may be configured such as the optical coupler 23 of the embodiment of FIG. 3. The photodetectors 24 to 27 may be configured such as the photodetectors 14 to 17.

FIG. 5 shows a diagram of the response of the optical frequency estimation filter in FIG. 4, with the horizontal axis representing the input optical frequency v and the vertical axis the optical phase difference φ at the two input ports of the 2×4 optical couplers 23′, 23 in either of the two A-MZIs: The solid line 45 shows the response for the fine filter including coupler 23, the dashed line 46 shows the response of the coarse filter including coupler 23′. The origin of the horizontal and vertical axes in FIG. 5 is chosen such that the origin defines an optical phase difference φ of −180°, whereas the maximum on the vertical axis is set at φ=180°. The phase 46 of the coarse filter increases linearly from −180 to 180 degrees, whereas the phase 45 of the fine filter includes several portions of linear increase. In this example the Mach-Zehnder interferometer (MZI) path length imbalance for the fine filter is six times greater than in the coarse filter. At an exemplary input optical frequency v₀ the phase of the coarse detector is φc and the phase of the fine detector is φf. At any given input optical frequency, φc and φf uniquely identify the optical frequency v within the free spectral range of the coarse detector.

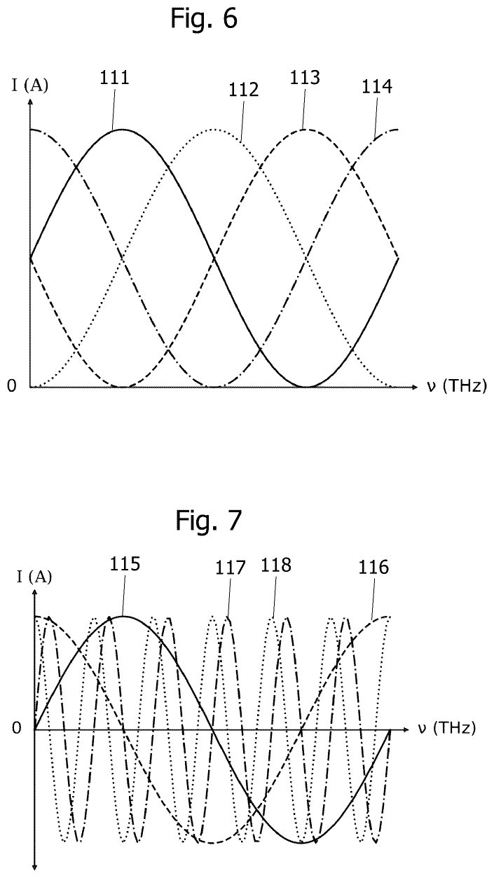

The four curves 111-114 in FIG. 6 show what each of the four photodetectors 14-17 in FIG. 3 detects as a function of the input optical frequency v, if the delay line 12 of the A-MZI is relatively short. The Y-axis corresponds e.g. to a current provided by a photodetector 14-17. A longer delay line 12 would increase the frequency of the sine waves 111-114 in the diagram.

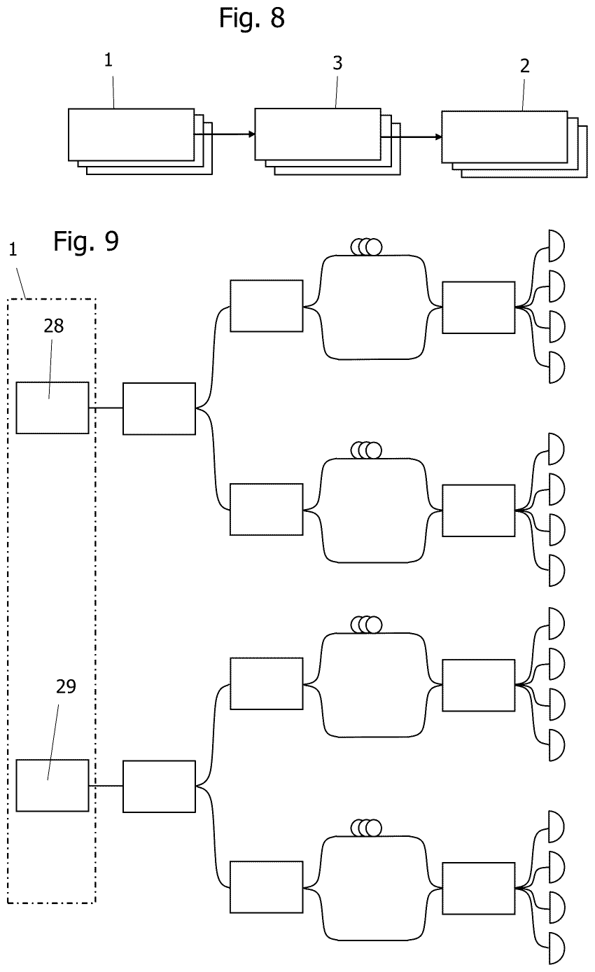

FIG. 7 shows the response of the photodetectors 14-17, 24-27 in FIG. 4 as a function of the input optical frequency v. To avoid the clutter of showing 8 curves in one plot, each of the four curves 115-118 corresponds to the signal of a pair of photodetectors 14 and 15, 16 and 17, 24 and 25, 26 and 27 in a differential configuration. The pair of low-frequency curves 115, 116 correspond to the signals from the coarse half (filter with optical delay line 12 in FIG. 4), and the pair of high-frequency curves 117, 118 correspond to the fine half (filter with optical delay line 22 in FIG. 4). FIG. 5 is a plot of the phases of the two quadrature signals in FIG. 7.

FIG. 8 shows a high level schematic of a chromometric sensor according to an embodiment of the invention. If the optical power of the laser is insufficient for the optical frequency estimator, it is possible to insert an optical amplifier 3 before the optical frequency estimator 2, for example a fiber amplifier or a semiconductor optical amplifier (SOA).

FIG. 9 shows a schematic of a chromometric sensor that uses both the differential noise suppression technique and the multi-A-MZI technique, comprising a first chromometric laser 28 and a second chromometric laser 29 that are mechanically coupled so that unwanted noise appears as a common mode signal in the frequency of both lasers. Different embodiments for differential chromometric laser pairs including the first chromometric laser 28 and the second chromometric laser 29 with mechanically coupled resonators are illustrated in FIGS. 8-11. In FIG. 9, the output light of laser 28 is received by a first arrangement with MZIs and the output light of laser 29 is received by a second arraignment with MZIs. Each arrangement may be configured such as the arrangement shown in FIG. 4.

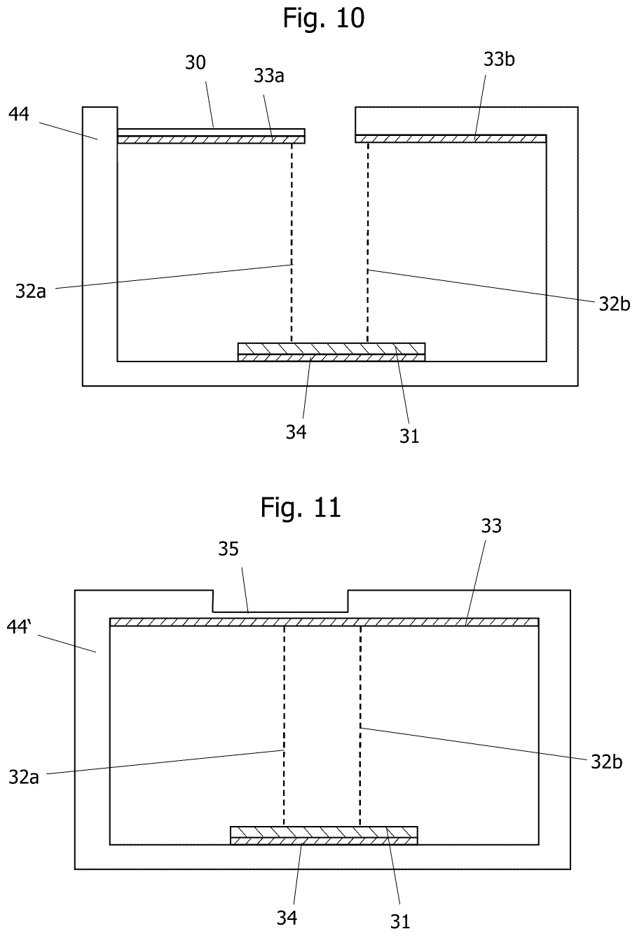

FIG. 10 shows a first embodiment of a differential chromometric laser pair for measuring the displacement of a cantilever 30. A pair of intra-cavity laser beams 32a, 33b is confined to the laser resonators defined by cavity mirror 33a, 33b and a cavity mirror 34. Cavity mirror 33a, 33b may form two separated mirrors or a single mirror interconnected. Mirror portion 33a placed on the cantilever 30 is part of the laser resonator for laser beam 32a. Mirror portion 33b is arranged immovably relative to mirror 34 and part of the laser resonator for laser beam 32b. For stabilization of the optical resonator, either or both of the cavity mirrors 33a, 33b, 34 may be curved. It is also possible to use thermal lensing or other refractive or reflective optics in the resonator for the stabilization, not included in FIG. 10. The optical cavity is designed to be stable also when the cantilever 30 is bent, i.e. when the angle of the mirror 33a on the cantilever 30 changes due to cantilever displacement; this is typically achieved by using optical elements with sufficiently strong focusing power in the optical resonator. For clarity, the laser pumping mechanism, output coupling, and optical frequency estimator 2 are omitted from FIG. 10. The gain medium 31 can be for example configured as a semiconductor disk or a solid-state laser crystal. Beside the physical quantity that should be measured, in this example, the cantilever displacement, certain other stimuli will affect the optical frequency of the left laser, for example, external vibrations and thermally induced motion. This results in unwanted noise that limits the resolution of the sensor if not removed. If the laser cavities are strongly mechanically coupled, such that the system has no resonance frequency in the frequency range of the sensed signal, such stimuli will cause nearly identical changes in the optical frequency of both lasers, making it possible to suppress the resulting unwanted noise with a differential measurement, to sense only true cantilever displacement. An example of a strongly mechanically coupled structure is a casing structure 44.

FIG. 11 shows a second embodiment of a differential chromometric laser pair for measuring the displacement of a membrane 35. This configuration is useful for measuring the static or low frequency pressure differential between the two sides of the membrane. The portion of the mirror 33 placed on the membrane 35 is part of the laser resonator for laser beam 32a. Another portion of mirror 33 is arranged immovably relative to mirror 34 and part of the laser resonator for laser beam 32b. The casing 44′ may include front and rear sides to form a closed chamber, in which the laser resonators are arranged.

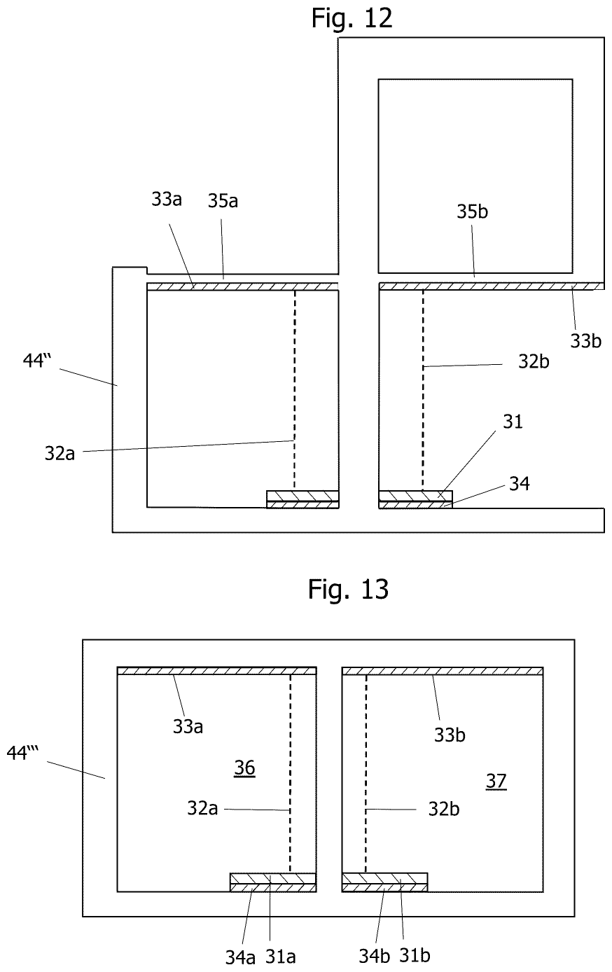

FIG. 12 shows a third embodiment of a differential chromometric laser pair for measuring the displacement of a first membrane 35a and a second membrane 35b. The side of membrane 35a, 35b facing the mirror 34 is provided with a mirror 33a, 33b. Instead of a single membrane 35 as in the embodiment of FIG. 11, the fixture 44″ comprises the first membrane 35a and the second membrane 35b, which are configured such that as a pressure change causes one of the first and second membranes 35a, 35b to move to prolong its laser cavity, and the other of the first and second membranes 35a, 35b moves to shorten its laser cavity. Thereby, a true differential system is created, as opposed to a pseudo-differential system, which increases the signal strength without increasing noise. The casing structure 44″ may be configured such that the chamber including the mirror 33a and a portion of mirror 34 and the chamber including the second membrane 35b are closed.

FIG. 13 shows a fourth embodiment of a differential chromometric laser pair for measuring a refractive index change. Instead of a cantilever 30 or one or more membranes 35, 35a, 36b, the laser cavities are rigid. The casing 44′″ is configured such that a first chamber 36 and 37 is formed, each of which may be closed. The first chamber 36 includes mirrors 33a, 34a and gain medium 31a to produce laser beam 32a. The second chamber 37 includes mirrors 33b, 34b and gain medium 31b to produce laser beam 32b. This configuration can be used to measure the refractive index changes in a first chamber 36 and/or in a second chamber 37. This is useful for example for gas sensing, in particular, it can be used for example to perform photothermal spectroscopy. One of the first or second chambers 36, 37 may be used as a reference chamber, where only the other contains the measured medium, forming a pseudo-differential sensor.

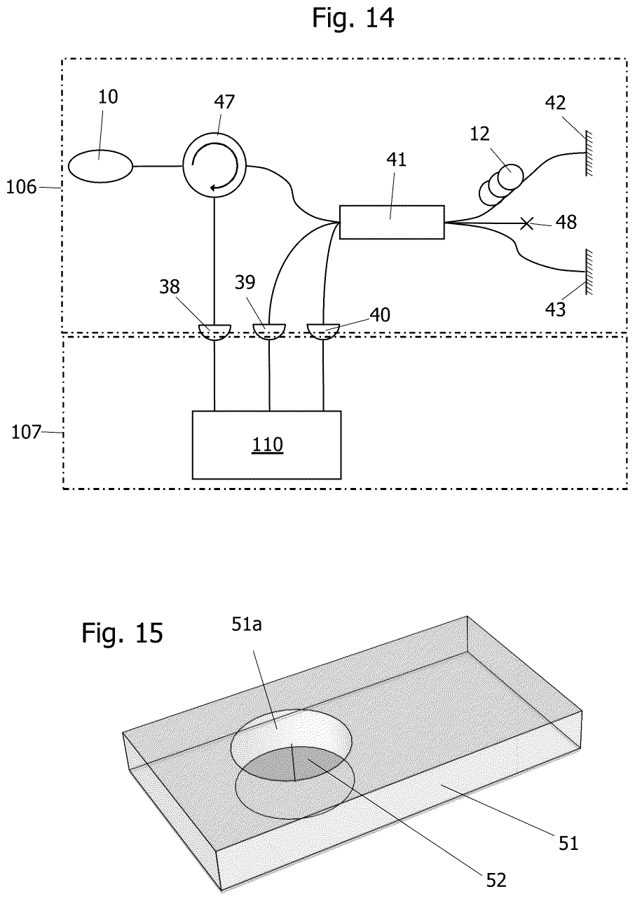

FIG. 14 shows a schematic of an asymmetric Michelson interferometer for estimating optical frequency, comprising an optical part 106 and an electronic part 107. It can be constructed using for example free-space optics, fiber optics or photonic integrated circuit technology.

The input laser beam 10 is directed, via an optical circulator 47, into an optical coupler 41, which splits the laser beam 10 into at least a first part and a second part, one of which is delayed using an optical delay line 12. Each of the first and second parts is separately directed back into the optical coupler 41 using mirrors 42, 43, where they are recombined. The combined laser beams are emitted from the optical coupler 41 e.g. in form of three signals offset by 120° and sent to photodetectors 38, 39, 40, one of them via the circulator 47. The optical coupler 41 acts here as an input and output coupler. It may be implemented for example with fused fiber couplers or multi-mode interference (MMI) couplers in a photonic integrated circuit. The optical delay line 12 may be implemented for example with a coiled fiber or a spiral waveguide in a PIC. The unused port of the optical coupler 41 is terminated with a non-reflective optical component 48, for example with a fiber optic terminator.

Just like with A-MZI based devices it is possible to use an optical coupler with different numbers of inputs and outputs than 3×3 as the coupler 41 of FIG. 14, for example 2×2 and 4×4. If the waveguiding is performed with optical elements that are not polarization maintaining, for example with non-polarization maintaining single mode fiber, the interferometer may suffer from detrimental polarization fading effects. This can be mitigated by using Faraday rotation mirrors for the mirror elements 42 and 43. Two or more arrangements with components 12, 38-43, 47, 48 as shown in FIG. 14 may be used instead of the arrangements with components 11-17, 20-27 of FIG. 4 to provide filters which different response ranges in that delay lines 12 with different lengths are chosen for the different Michelson interferometers.

Chromometric sensors are capable of achieving very high resolution and dynamic range while consuming little power. Improvements, in particular optimizations are possible by providing 1) an optical frequency estimator with resolution and dynamic range that matches the performance of the sensing element, 2) a laser with preferably near-quantum-limited effective frequency noise performance, 3) a laser that is suitable for chromometry.

The following text starts with a theoretical explanation of what the performance limits of this technology are, followed by methods to obtain each of these three performance improvements as compared to the current state-of-the-art. Finally, the last section outlines examples of how high-performance chromometric sensors can be constructed to sense specific physical quantities.

### Theoretical Motivation

The following is a high level mathematical sketch to explain why chromometric sensing is capable of providing high resolution with low optical power. It assumes that the system's dominant noise source is Schawlow-Townes phase noise in the laser, an assumption that is sufficiently accurate if optimization methods presented later are applied.

The Schawlow-Townes linewidth is

$$\text{?}$$

$$\text{?} \text{indicates text missing or illegible when filed}$$

where T_{OC} denotes output coupler transmission, Iₜₒₜ the total resonator losses, Tᵣₜ the resonator roundtrip time, Pout the output power produced by the laser, h is Planck's constant, and θ the spontaneous emission factor. Assuming ideal conditions of θ=1 and Iₜₒₜ=T_{OC}, we have

$$\text{?}$$

$$\text{?} \text{indicates text missing or illegible when filed}$$

The phase noise limited signal-to-noise ratio (SNR) of the sensor is SNR=CTR/v_{RMS} where v_{RMS} is the RMS (Root Mean Square) optical frequency noise in the frequency range of the sensed signal and CTR is the laser's continuous tuning range, here assumed to be the laser cavity free spectral range (FSR) (spacing of the axial resonator modes of the resonator in terms of optical frequency),

$$\text{?}$$

$$\text{?} \text{indicates text missing or illegible when filed}$$

where c is the speed of light and n_{g} is the refractive index of the medium. Assuming vacuum (n_{g}=1) we have FSR=c/2L, or equivalently FSR=1/(2Tᵣₜ).

Moving on to the RMS optical frequency noise:

$${v}_{RMS} = \sqrt{\frac{Δ v \cdot Δ f}{π}}$$

(using a rule of thumb for converting linewidth to spectral noise density) where Δf is the bandwidth of the sensed signal. Putting all this together gives

$$\text{?}$$

$$\text{?} \text{indicates text missing or illegible when filed}$$

From this formula it is clear that by increasing output power, the SNR scales at the same rate as with classical interferometry (and consequently also the resolution, because it is the noise floor that is reduced), but the SNR is also proportional to T_{OC}⁻¹, which is approximately equal to the average photon roundtrip count in the laser cavity. This number can be increased without increasing optical power, and although there is a practical limit to how far it can be pushed, this practical limit is in some applications greater than the practical limit of techniques based on interferometry with engineered quantum states.

### Optical Frequency Estimation

The following section outlines methods for measuring the optical frequency of chromometric lasers. The optical frequency estimator should ideally have comparable or higher resolution than the frequency noise of the laser. A simple way of doing this is to use a Mach-Zehnder interferometer with unequal path lengths of each interferometer arm, an A-MZI, see FIG. 2. In such a setup, changes in optical frequency cause changes in the intensity of the light in the outputs of the interferometer. By using a path length imbalance that is much longer than the optical wavelength it is possible to measure very small changes in optical frequency, typically enough to make the frequency noise of the light output of the laser the dominant source of noise.

A simple implementation of this A-MZI that provides only one signal or two signals that are 180° out of phase suffers from two problems: 1) When calculating the optical phase from the input signal, the noise of the phase estimation depends on the optical phase (the phase angle estimation error increases when the signal is close to a maximum or a minimum), which results in suboptimal performance and undesired distortion, 2) it is in general not possible to discern negative and positive change. There are multiple techniques for mitigating these issues: One approach that works well is to use 3×3 or 44 optical couplers where the two interferometer arms meet, which produce signals that are offset by 120° or 90°, see FIGS. 3 and 12. This avoids both aforementioned issues.

Because of the potentially long optical path lengths in the MZIs it is necessary to sufficiently isolate the MZIs from external influences such as acoustic vibration and thermal variations. If the MZI is made from waveguides in a photonic integrated circuit chip, this is unlikely to be a problem, because such chips are mechanically stable, and propagation losses typically limits the waveguide length before optical path length stability becomes a concern. If optical fibers are used it is typically sufficient to package the fiber in a mechanically stable and thermally isolating enclosure. The MZI based designs described here will, if implemented using fiber optics, preferably apply polarization maintaining fiber or some other form of polarization control to avoid polarization fading.

Using known signal processing methods it is possible to use an A-MZI based optical frequency estimator to estimate the optical frequency modulo some free spectral range (FSR) that is inversely proportional to the path length imbalance. Assuming a static optical frequency and no optical losses, the resolution is proportional to the path length imbalance. A drawback of using a very large path length imbalance in an A-MZI based optical frequency estimator is that although it results in very high resolution, it also reduces the range of frequencies that can be measured unambiguously; despite increasing the resolution, the overall SNR remains shot noise limited just like with a classical interferometer.

This problem can be mitigated by using a system of two or more A-MZIs in parallel, each with different path length imbalances, see FIG. 4. For example, in a system of one “coarse” and one “fine” A-MZI, where the fine A-MZI has a path length imbalance 1000 times greater than the coarse A-MZI, the readout from the coarse A-MZI might be able to determine the optical frequency modulo 1 THz, whereas the fine A-MZI would be able to determine the optical frequency modulo 1 GHz. As long as the error of the coarse A-MZI readout is less than the FSR of the fine A-MZI it is possible to combine the readouts of the two A-MZIs to obtain an optical frequency estimate with the resolution of the fine A-MZI and the dynamic range of the coarse A-MZI, simply by using the coarse A-MZI to determine the more significant digits and the fine A-MZI to determine the less significant digits of the output in a number base that divides the path length imbalance multiplier, taking special care of rounding the least significant digit in the coarse readout so that the final estimate is within the uncertainty range of the coarse readout as shown in FIG. 5. For example, if the coarse A-MZI readout is that v % 1 THz≈143.54 GHz with an error of less than 0.5 GHz and the fine A-MZI readout is that v % 1 GHz=265 MHz, it can be deduced that v % 1 THz=143.265 GHz. Here, % means modulo.

It is possible to use more than two A-MZIs, for example three with path length imbalances of 10 μm, 10 mm and 10 m. It is even possible to use one A-MZI for each bit of dynamic range, with each A-MZI having double the path length difference of the next shorter one in the system.

As long as the readout error in a coarse A-MZI is less than half the FSR of the next finer A-MZI, the error is fully corrected, but any error greater than this threshold results in a readout error that is equal to a multiple of the FSR of that A-MZI, which is typically large. The number of A-MZIs, their relative path length imbalances, the relative optical power sent to each A-MZI, and the noise of their respective photodetector circuits have an impact on the statistical error distribution of an optical frequency estimator of this type. The error distribution can be calculated using known statistical methods, which allows tuning the design to obtain a behavior that is suitable for a given application.

A benefit of this multi-A-MZI optical frequency estimation scheme is that it makes it possible to use several low-resolution analog-to-digital converters (ADCs) instead of a single high-resolution ADC. For example, it might be possible to use three coarseness levels each with 10 bits of resolution to obtain 24 bits of total resolution. This is beneficial for a number of reasons:

1. Low resolution successive approximation register (SAR) ADCs can consume several orders of magnitude less power than a high resolution AZ ADC. For example, an audio-rate AZ ADC with 21 bits of resolution may consume 100 mW per channel, while a 10 bit SAR ADC may consume only tens of microwatts. Even though this scheme requires several ADC channels, the total ADC power consumption can be hundreds of times lower for a single ADC channel with equal resolution.

2. It is not only ADC power consumption that is reduced: Using lower resolution per ADC channel also reduces the required optical power. With shot-noise limited photodetectors, each bit of ADC resolution reduction results in a fourfold reduction in the required optical power. For example, a readout with 22 bits of resolution requires more than one million times more optical power than a readout with 12 bits of resolution at the same bandwidth.

3. There is a practical upper limit for the achievable resolution of AZ ADCs. For audio-rate converters, there are currently no ADCs on the market with 22 bits or higher SNR. A chromometric sensor with a multi-A-MZI optical frequency estimator can readily exceed this.

In summary, this method results in a system that consumes significantly less power both for electronics and the laser and with higher dynamic range than what is possible with a classical interferometer.

Although the multi-A-MZI scheme makes it possible to use low resolution ADCs, it is typically not feasible to push this all the way to its extreme using only 1-bit ADCs, because this requires both very long path length imbalances, which leads to issues further described below, and a very large bandwidth requirement for the ADC.

A limitation of the multi-A-MZI scheme is that if the tuning range of the laser is very small, it might be necessary to use very long path length imbalances. This can result in issues related to comb filtering of the input signal because of the long delay line or issues related to optical losses, particularly if the optical frequency estimator is implemented with photonic integrated chip technology. In cases where the tuning range of the laser is small and cannot be increased, the optical frequency estimator may instead be implemented by combining two lasers with similar optical frequencies, whose optical frequency difference is modulated by the physical quantity that is to be sensed, to form a beat note, and then estimating the frequency of the beat note. If the two laser frequencies are sufficiently close, this can for example be done by measuring the beat note directly with a photodetector. Frequency estimation algorithms exist that make it possible to achieve a resolution that scales linearly with the optical power of the laser beams. With this method it is also possible to achieve a very large dynamic range and very low requirements on optical power, with moderate power consumption.

Instead of using Mach-Zehnder interferometers, which have separate optical couplers (11, 13, 21, 23) for splitting and merging beams, it is also possible to use a Michelson interferometer with only one optical coupler that simultaneously splits and merges beams, see FIG. 14. The signals produced at the photodetectors of such a configuration may be used alternatively to a corresponding A-MZI based frequency estimator to estimate the frequency.

A complementary or supplementary method that can be employed to estimate the optical frequency of a chromometric laser if the chosen frequency estimator requires more optical power than what is available from the laser is simply to use an optical amplifier in between the chromometric laser and the optical frequency estimator, see FIG. 8.

The methods described above make it possible to estimate the optical frequency of the light output of the laser with sufficient resolution that the frequency noise of the light output of the laser itself will be the dominant noise source.

### Differential Noise Suppression

The previous mathematical formulae assume that Schawlow-Townes quantum noise is the only laser phase noise. For virtually all lasers, the phase noise is much higher than this for all but very high frequencies. This additional noise above the quantum limited noise comes from various technical sources such as mechanical vibrations and thermal fluctuations. Some noise sources can be eliminated with careful engineering, but not all. For example, thermal motion in the laser resonator, particularly in the mirrors, is a source of phase noise that is difficult to avoid.

Instead of attempting to fully eliminate this noise, it is possible to suppress it by means of differential readout where two or more lasers are constructed such that the unwanted noise is present with high correlation in the light output of more than one laser.

In some embodiments, two or more such lasers are constructed such that their resonators are mechanically coupled at the frequency range of the sensed signal, see FIG. 10, FIG. 11, FIG. 12, FIG. 13. For example, the frequency range of the sensed signal for a microphone for sound are 20-20,000 Hz. This technique makes it possible for a differential optical frequency measurement device to suppress optical frequency noise caused by mechanical motion of the resonators, such as those caused by thermal effects.

Mechanical coupling of the two laser resonators in the frequency range of the sensed signal can be achieved if the resonators are physically close to each other, the mechanical construction of the sensor is stiff, and any compliant mechanical element in the sensor such as a membrane is engineered to have eigenfrequencies outside of the frequency range that is measured by the sensor.

For example, a chromometric microphone can include two lasers whose resonators are less than 1 mm apart, and the mechanical structure that holds the optical elements in the laser resonators can be constructed out of a mechanically monolithic piece of silica with 1 mm thick walls. Furthermore, the membrane of the microphone needs to have eigenfrequencies above the frequency range of the sensed signal, in this case 20 kHz that is the highest sound frequency. A mechanical system is less stiff at its eigenfrequencies, so the mechanical coupling is relatively weak at the eigenfrequencies, which is detrimental for the efficacy of the differential noise suppression.

In some embodiments, two or more such lasers are constructed such that they are pumped with highly correlated power sources. For example, if the lasers are electrically pumped, they can be connected in series, and if the lasers are optically pumped, they can be pumped with a single optical beam that is split in two with a beamsplitter. This technique makes it possible for a differential optical frequency measurement device to suppress optical frequency noise caused by pump noise, for example via temperature variations in the resonators caused by variations in pump power.

By combining the aforementioned techniques for high resolution optical frequency estimation and differential noise suppression, see FIG. 9, it is possible to build a system where much of the noise originates from the Schawlow-Townes phase noise of the laser. As predicted by the formulae above, such a system can enjoy a significant resolution boost when compared to interferometric sensors, in particular if the laser has suitable properties.

### Laser Selection and Design

The following section outlines what properties one may look for when selecting a laser for chromometry. Although many different lasers can be used to construct a chromometric sensor, most laser architectures do not perform well in this context. First off, it is preferred to use lasers with single frequency output. The previous section hints that a key to good performance is to maximize the average photon roundtrip count. Here the design criteria are explored in greater detail.

From the equations above we have that

$$\text{?}$$

$$\text{?} \text{indicates text missing or illegible when filed}$$

Assuming Δf is constant we can define a figure-of-merit FoM=CTR²/Δv, where maximizing FoM maximizes the SNR of the sensor. From this it is possible to see that the ideal laser for chromometric sensing has small linewidth, but also a large continuous tuning range, which in most cases requires a short laser cavity. These are conflicting requirements, and most laser architectures feature relatively poor FoM. For example, fiber lasers can have very small linewidth, but they also feature a small continuous tuning range. Microring lasers often have a very large tuning range, but may have a poor linewidth. With this in mind, it is clear why the prior art in chromometric sensors have not achieved very good performance; they all used lasers with a poor FoM.

Preferred embodiments use lasers selected with these criteria in mind: Semiconductor disk lasers (SDLs) and thin-disk lasers are examples of laser architectures that perform well for this kind of sensor.

Semiconductor disk lasers and thin-disk lasers share many important properties that are beneficial for chromometry, but thin-disk lasers, which can be implemented with four-level gain media with low spontaneous emission factor θ and linewidth enhancement factor promise superior performance, while SDLs may be cheaper to fabricate and allow for electrical pumping which can improve power efficiency and reduce packaging costs.

Many solid-state laser gain media can be used, but it can be beneficial to use a relatively short laser cavity in order to more easily obtain single-frequency laser emission and achieve a wide tuning range, which can simplify the frequency estimator component of the sensor. This favors using gain media with relatively large absorption coefficients, for example Nd:YVO₄ crystals, or highly doped Nd:YAG ceramics, which are both four-level laser media suitable for chromometric sensors. It is not only the absorption coefficient that sets a lower limit to the laser cavity length; the gain bandwidth of the laser medium imposes a separate limit to how wide the laser's tuning range can be.

The gain medium in an SDL can be engineered to have orders of magnitude smaller absorption length and larger gain bandwidth than most solid-state laser crystals; it is not unusual for an SDL to have 10 nm or wider gain bandwidth, compared to about 1 nm that is typical for Neodymium doped crystals, and to be only single digit microns thick, compared to solid state crystals which are rarely less than hundreds of microns thick. These properties make it possible to design extraordinarily compact SDL based chromometric lasers. In addition, their wide tuning range allow using A-MZI based frequency estimators with relatively small path length imbalances, small enough that they can be implemented entirely on a PIC.

In many applications of chromometric sensors, the wavelength of its chromometric laser does not matter. For this reason, the material system used for an SDL based chromometer can in many cases be chosen to optimize for cost and power efficiency: The widely used InGaAsP material system operating at around 1 micron wavelength is a suitable choice. Another option is dilute nitride based designs which can emit light at slightly longer wavelengths, long enough to be compatible with silicon photonics. This can be beneficial, because it allows using a silicon based PIC for frequency estimation.

Many SDL designs are optimized for high power output. This is generally not necessary for chromometric lasers, where it is typically a higher priority to optimize for low power consumption and high laser resonator finesse. An SDL optimized for chromometry may turn out rather different from one optimized for high power. For example, reducing the number of quantum wells can reduce threshold power and the spontaneous emission factor θ. In addition, it can be beneficial to design the laser resonator to be short and with mirror curvatures that minimize the mode field diameter (MFD) at the gain medium, to reduce the threshold power. In fact, it can be beneficial to use a MFD in the single digit microns range, much smaller than typical SDL designs and more akin to vertical-cavity surface emitting lasers (VCSELs). With such a small MFD, similar to the thickness of the SDL chip, the heat generated in the gain medium will dissipate not only vertically but also to a significant degree to the sides. This is also more akin to a VCSEL than a typical SDL and significantly impacts the heat management of the device, which is a crucial aspect of the design of any SDL.

In laser design it is common to select the output coupler transmissivity to maximize output power. For chromometric lasers this is generally not optimal; it is typically better to optimize for minimum linewidth, which can result in output coupler transmissivity that gives less than maximal output power. Parasitic losses in the laser resonator have a large influence in this optimization process and it is greatly beneficial to minimize them.

### Methods for Measuring Specific Physical Quantities

This final section outlines ways that the present invention can be used for sensing specific physical quantities. The present invention can measure optical path length in a variety of situations and is applicable for measuring a wide variety of things, including pressure, sound, ultrasound, displacement, temperature, acceleration, rotation, voltage or electric fields, and concentrations of specific chemicals.

FIG. 11 and FIG. 12 illustrate differential chromometric laser pairs with membranes 35, 35a, 35b. Such configurations can be used for sensing pressure. By adding a small opening in the respective closed chamber for pressure equalization this configuration can be used for sensing only acoustic waves (sound and ultrasound) without taking constant and low frequency pressure changes into consideration.

FIG. 10 illustrates a chromometric laser pair with a cantilever 30. This configuration can be used to sense acoustic waves. By controlling the speed of pressure equalization between the two sides of the cantilever, or by placing it inside of a vacuum, such a configuration can instead be used for inertial sensing. Various mechanical shapes (as is for example found in MEMS sensors) can be used to make the sensor sensitive to specific types of inertial motion (for example rotation or acceleration in different axes).

FIG. 13 illustrates a chromometric laser pair with fully rigid optical cavities. Instead of measuring displacement of a structural element such as element 30, 35, 35a, 35b, such a configuration can be used to measure changes of refractive index. This can be used to sense temperature and pressure. By modulating the intensity of at least one of the lasers, or by using a separate pump beam, it is possible to perform photothermal spectroscopy to measure concentrations of specific gasses. For example, it is possible to measure the concentration of a specific gas by shining a separate laser beam through the optical cavity 37, where this laser beam has a wavelength that is highly absorbed only by that gas, and periodically switching this laser on and off. This will cause the temperature of the gas inside the optical cavity 37 to vary with the same frequency as the switching frequency of that laser. The temperature change causes a change in refractive index of the gas, which can be measured by the chromometric sensor.

All of the preceding examples can easily be implemented using free-space optics for laser pumping and frequency estimation, but for miniaturization and cost efficiency it is greatly beneficial to use PIC technology. One way to do this is to let the mirror 34, 34a, 34b next to the gain medium 31 be the output coupler mirror of the laser, and place it directly on top of a vertical coupler of a PIC that captures and processes the emitted light.

The aforementioned examples can be combined with any optical frequency estimation mechanism, including the beat note method and the multiple-A-MZI or Michelson interferometer method outlined above. They can also be applied with and without a differential laser pair. However, the combination of the differential laser pair and multiple-A-MZI/Michelson interferometer techniques uniquely solve problems with previous chromometric sensor designs and allows for great resolution, dynamic range and power consumption in such a sensor.

In the following examples of producing a sensor, which is applicable for pressure sensing or microphone, are illustrated, see FIG. 15 to 24.

One possible fabrication of a sensor with a membrane, which is useable e.g. as a microphone, is as follows:

Providing a membrane chip, see FIG. 15

1. A substrate 51, e.g. cut from a silicon wafer, is provided.

2. A thin layer of material that will act as the membrane is deposited on the substrate 51. A common material choice is Silicon Nitride.

3. A mirror is deposited on top of said material. The reference sign 52 in FIG. 14 denotes the mirror and membrane.

4. A hole 51a is etched into the substrate 51 to form the membrane with the mirror 52.

In this embodiment, the mirror on the membrane is highly reflective. Here, it does not act as the output coupler mirror of the laser resonator.

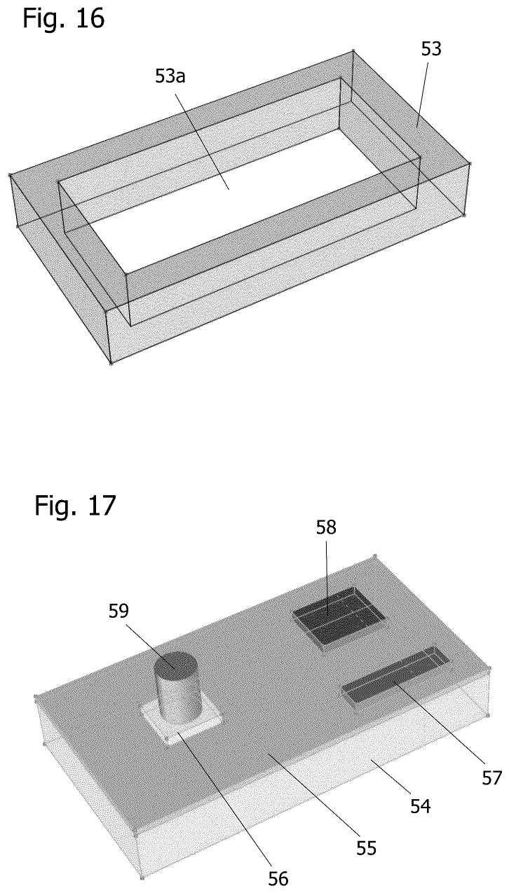

Providing a spacer, see FIG. 16

1. A substrate 53 of a suitably rigid material (for example glass, silicon, silicon carbide or ceramic) is provided.

2. An inner part 53a of the substrate 53 is removed by e.g. cutting out sidewalls.

Providing the PIC, see FIG. 17

1. A PIC is provided, which may be available e.g. from a photonics foundry. The PIC is e.g. constructed from a silicon substrate 54 and a functional layer 55 arranged thereupon. The functional layer 55 includes the PIC waveguides and is made for example from silicon dioxide with silicon nitride embedded inside of it that form the PIC waveguides.

2. An active mirror 56 e.g. in form of a semiconductor disk laser (SDL) chip or another device including a mirror with a gain medium is put on top of the unit 54, 55.

3. Optionally, other components may be put on the unit 54, 55, for example an array of photodetectors 57 and electronic processing circuitry 58 in form of e.g. an ASIC chip, for performing the electronic functions of the sensor, e.g. a microphone. Said components 57, 58 may also be placed outside of the unit 54, 55, which may be e.g. part of a microphone capsule.

4. It may be beneficial to provide for further measures to stabilize the laser resonator. For example, an intracavity microlens 59 may be provided, in FIG. 17 illustrated as a cylinder on top of the SDL chip 56, because it is beneficial to place the lens 59 on a “pillar” a bit away from the SDL chip 56.

In the configuration of FIG. 17, the SDL chip 56 is configured to emit laser light downwards towards the PIC 54, 55. In order for this setup to work, it's necessary to couple the vertical laser light emitted from the SDL chip 56 into the horizontal waveguides of the PIC 54, 55. This may be done e.g. by means of a vertical coupler. Vertical couplers can be constructed using a grating in the PIC (such couplers are called vertical grating couplers). It's also possible to use a 45 degree total internal reflection mirror. Another possibility is to insert a separate chip between the PIC 54, and the SDL chip 56 that serves as an interposer to assist with the vertical coupling.

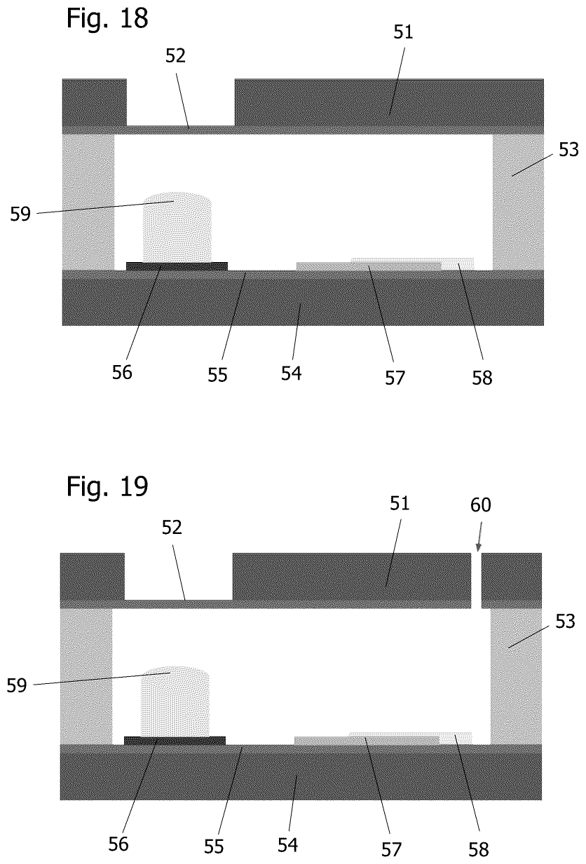

Assembling the different components, see FIG. 18

The sensor e.g. in form of a microphone is finally constructed by placing middle layer composed of the spacer 53 on top of the bottom layer including the PIC 54, 55, and then placing the top layer including the membrane chip 51, 52 on top of the spacer 53 and fixing them together, for example by welding them or soldering them together.

In this embodiment, the top layer 51, 52, middle layer 53 and bottom layer 54. 55 together constitute a carrier for the laser resonator.

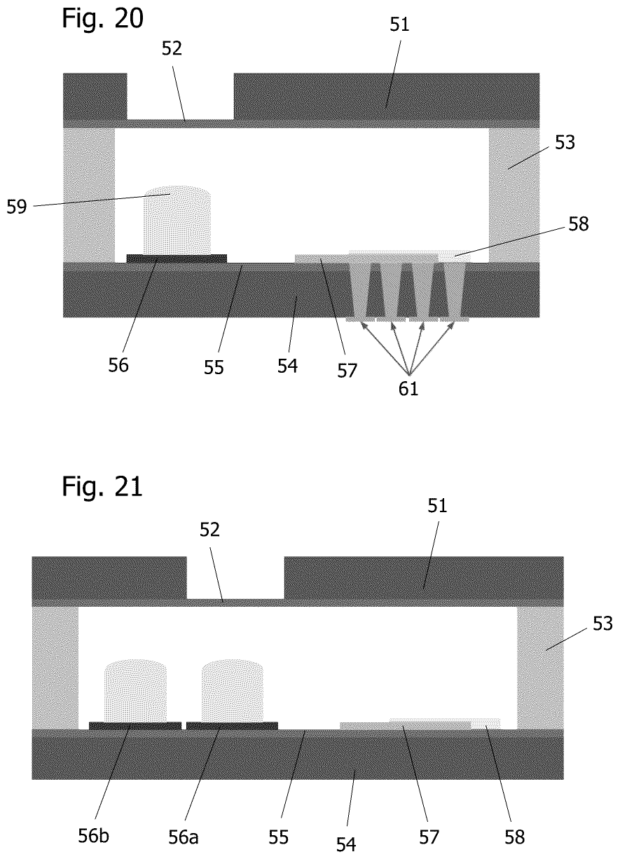

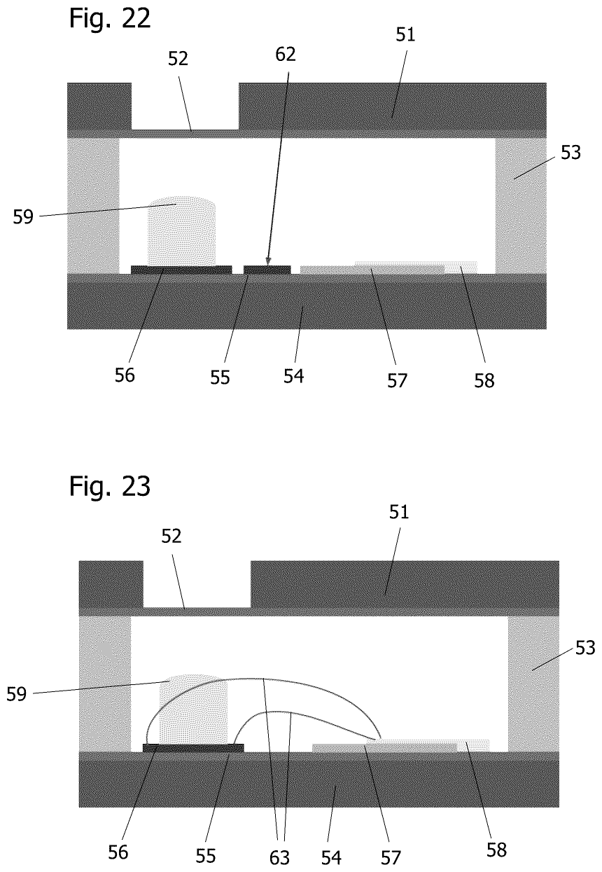

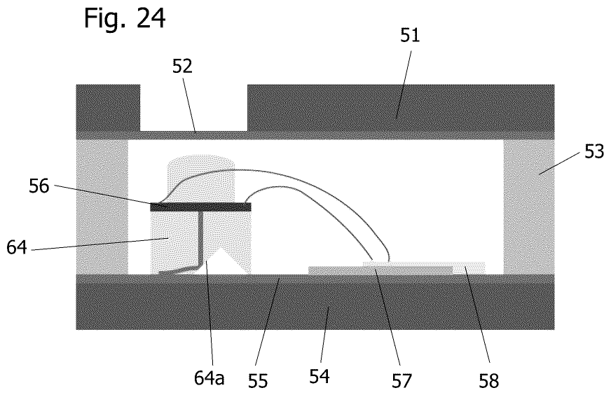

Numerous variants of the configuration shown in FIG. 18 are conceivable:
The membrane sensor of FIG. 18 is particularly suited as a pressure sensor. If used as a microphone, the sensor may be provided with a vent 60, so that the membrane 52 does not sense static pressure. The vent 60 may be provided e.g. on the top layer 51 as shown in FIG. 19 or in another part of the sensor.
In FIG. 18 the electronic connections between the electronics 58 and the photodetectors 57, and between the electronics 58 and the outside world are not shown. These connections may be provided e.g. by means of through-silicon vias (TSVs) 61 in the PIC 54, 55 as illustrated in FIG. 20.
In FIG. 18 a sensor with only a single laser is shown. If the measuring accuracy of the sensor is to be increased, two or more lasers are provided as explained above. In FIG. 21 an embodiment with a first and second laser 56a, 56b is shown. The first laser 56a is arranged opposed to the membrane with the mirror 52 and the second laser 65b is arranged opposed to the mirror, which is immovably attached to substrate 51.
laser chip 56 may e.g. be optically pumped. FIG. 22 shows an embodiment with a pump laser 62 arranged on the PIC 54, 55. Pump light produced by the pump laser 62 can be coupled into the PIC 54, 55 and then sent to the laser chip 56 e.g. via the same vertical coupler that couples the laser output into the PIC 54, 55.
The laser chip 56 may also be electrically pumped. In that case the power is supplied to the laser chip 56 via electronic connections as indicated in FIG. 23 by lines 63. The electrical connections may be created using wire bonds.
FIG. 24 shows a variant, in which an interposer chip 64 is arranged between the laser chip 56 and the PIC 54, 55. The interposer chip 64 can help provide the vertical coupler function. It can also reduce the length of the laser cavity, which can be beneficial. The interposer chip 64 may have waveguides and a total internal reflection mirror 64a to redirect the vertical light to be horizontal. The interposer chip 64 may use evanescent coupling to couple the light into the PIC 54, 55.

It is obvious to a person skilled in the art that many further variants are possible in addition to the embodiments described without deviating from the inventive concept. The subject matter of the invention is therefore not restricted by the preceding description and is determined by the scope of protection which is defined by the claims. The broadest possible reading of the claims is authoritative for the interpretation of the claims or the description. In particular, the terms “contain” or “include” are to be interpreted in such a way that they refer to elements, components or steps in a non-exclusive sense, which is intended to indicate that the elements, components or steps can be present or are used that they can be combined with other elements, components or steps that are not explicitly mentioned.

1. An optical path length sensor for sensing a physical quantity of an external source, comprising:
a plurality of lasers, wherein each of the lasers comprises an optical resonator and a gain medium to produce by means of a pump source a laser beam in the optical resonator, wherein at least one of the optical resonators is configured to modulate the optical frequency of the laser beam in said at least one optical resonator when exposed to the external source;
a common carrier, in which the optical resonators are arranged; and
a device configured to receive light from the plurality of lasers and to determine a difference between the optical frequencies of the laser beams.

2. The sensor of claim 1, wherein the optical resonators include a first and a second optical resonator arranged on the common carrier, wherein the first and/or second optical resonator is/are configured to modulate the optical frequency of the respective laser beam when exposed to the external source and/or wherein the sensor comprises
an open chamber receiving the first and the second optical resonator,
one or more closed chambers receiving the first and the second optical resonator, or
an open chamber receiving the first optical resonator and a closed chamber receiving the second optical resonator.

3. The sensor of claim 1, wherein each optical resonator comprises optical elements for redirecting light in the respective optical resonator, wherein preferably each of the optical element is a mirror or a waveguide.

4. The sensor of claim 3, wherein the at least one of the optical resonators is a first optical resonator comprising a first optical element and a second optical element, which have at least one of the following features A1) to A6):
A1) the first optical element is movably or immovably arranged with respect to the second optical element,
A2) the first optical element is arranged on a deformable element, in particular a cantilever or membrane,
A3) the second optical element is arranged on a photonic integrated circuit,
A4) the second optical element is configured as an output coupler for the laser beam, preferably the second optical element is placed on top of a vertical coupler of a photonic integrated circuit,
A5) the first optical element and the second optical element are arranged in a closed chamber, which preferably includes a vent and/or inlet for a medium as external source,
A6) the first optical element is a mirror including a plane or curved surface and/or the second optical element is a mirror including a plane or curved surface.

5. The sensor of claim 3, wherein one of the optical resonators other than the at least one of the optical resonators is a second optical resonator comprising a third optical element and a fourth optical element, which have at least one of the following features B1) to B6):
B1) the third optical element is movably or immovably arranged with respect to the fourth optical element,
B2) the third optical element is arranged on a deformable element, in particular a membrane,
B3) the fourth optical element is arranged on a/the photonic integrated circuit,
B4) the fourth optical element is configured as an output coupler for the laser beam, preferably the fourth optical element is placed on top of a vertical coupler of a/the photonic integrated circuit,
B5) the third optical element and the fourth optical element are arranged in a/the closed chamber, which preferably includes a vent and/or inlet for a medium as external source,
B6) the third optical element is a mirror including a plane or curved surface and/or the fourth optical element is a mirror including a plane or curved surface.

6. The sensor of claim 1, which includes at least one of the following features C1) to C6):
C1) at least one pump source for optically pumping one or more of the lasers,
C2) an optical pump source for emitting a beam of light that is split and used to pump at least two lasers,
C3) at least one pump source for electrically pumping one or more of the lasers,
C4) an electrical current source that is configured to pump at least two lasers,
C5) at least one of said gain media is one of a semiconductor gain medium, in particular a gain medium for forming a semiconductor disk laser, or a solid-state gain medium, in particular a solid-state crystal,
C6) the plurality of lasers are configured to be tunable.

7. The sensor of claim 1, wherein the carrier comprises a first layer, a second layer and side walls arranged therebetween for forming a hollow structure, wherein each optical resonator of the plurality of optical resonators comprise a first mirror arranged on the first layer and a second mirror arranged on the second layer, wherein preferably the first mirrors and the second mirrors each comprise a reflective coating on a substrate.

8. The sensor of claim 1, wherein
the optical resonators are configured to act as a rigid body, and, in use, at least one beam path inside at least one optical resonator passes through a gas or liquid medium, or
the optical resonators comprise a mirror embedded on a membrane or cantilever that, in use, moves when it is exposed to sound or changes in ambient pressure, and/or
at least one of the optical resonators comprises a mirror embedded on a cantilever that is configured to move when it is exposed to an external acceleration or rotation force.

9. The sensor of claim 1, wherein the device for determining a difference between the optical frequencies comprises
a plurality of interferometers for receiving light from the lasers, wherein each of the interferometer is an asymmetric Mach-Zehnder or asymmetric Michelson interferometer and is provided with an output optical coupler having a plurality of output ports, wherein at least two of the plurality of interferometers have a different optical path length imbalance;
a plurality of photodetectors, each coupled to one of the output ports; and
electronic processing circuitry for receiving signals from the plurality of photodetectors to compute the optical frequency of each of the laser beams.

10. An optical path length sensor for sensing a physical quantity of an external source, comprising:
at least one laser, which is configured to emit a laser beam having an optical frequency, wherein the at least one laser is configured to modulate the optical frequency of the laser beam when exposed to the external source;
a plurality of interferometers for receiving light from the at least one laser, wherein each of the interferometer is an asymmetric Mach-Zehnder or an asymmetric Michelson interferometer and is provided with an output optical coupler having a plurality of output ports, wherein at least two of the plurality of interferometers have a different optical path length imbalance;
a plurality of photodetectors, each coupled to one of the output ports; and
electronic processing circuitry for receiving signals from the plurality of photodetectors to compute the optical frequency of the laser beam.

11. The sensor of claim 10, which has at least one of the following features D1) to D7):
D1) the at least two of the plurality of interferometers have each two arms with a different optical length, the difference between the two arms defining the optical path length imbalance, wherein the ratio of the optical path length imbalances of the at least two interferometers is at least 10:1, preferably at least 100:1, most preferably at least 1000:1,
D2) the at least two of the plurality of interferometers comprise an optical delay line to provide for the optical path length imbalance, preferably the optical delay line being provided by a fiber or a waveguide in a photonic integrated circuit, most preferably the optical delay line being provided by a coiled fiber or a spiral waveguide in a photonic integrated circuit,
D3) the at least two of the plurality of interferometers serve each as a filter whose response with regard to the phase shift as a function of the frequency has a filter period, wherein the at least two of the plurality of interferometers have a different filter period, wherein the ratio of the filter periods is at least 10:1, preferably at least 100:1, most preferably at least 1000:1,
D4) each output optical coupler has at least three output ports, preferably at least four output ports,
D5) the at least two of the plurality of interferometers are arranged optically in parallel and connected to an input optical coupler device for receiving light from the at least one laser,
D6) the at least one laser is one of a semiconductor laser or a solid-state laser,
D7) at least one optical amplifier is provided for amplifying light to be received by one or more of the interferometers, preferably the optical amplifier being a fiber amplifier or a semiconductor optical amplifier.

12. The sensor of claim 10, wherein the interferometers include waveguides in a photonic integrated circuit.

13. The sensor of claim 10, comprising at least two lasers, wherein the electronic processing circuitry is configured to compute a difference between the optical frequency of the at least two lasers.

14. The sensor according to claim 1, which is configured to sense one or more of the following physical quantities: pressure, sound, ultrasound, displacement, temperature, force, acceleration, rotation force, voltage, an electric field, refractive index, concentration of one or more specific chemicals, in particular the sensor is a microphone for sensing sound in a given range, which preferably includes 20 Hz to 20 kHz.
